(19) United States
(12) Patent Application Publication
(10) Pub. No.: US 2025/0326239 A1
(43) Pub. Date: Oct. 23, 2025

(54) IMAGE FORMING APPARATUS THAT CONTROLS PRINTING IN ACCORDANCE WITH OPENING AND CLOSING OF CONTAINER COVER

(71) Applicant: KYOCERA Document Solutions Inc., Osaka (JP)

(72) Inventor: Takuya FUKATA, Osaka (JP)

(73) Assignee: KYOCERA Document Solutions Inc., Osaka (JP)

(21) Appl. No.: 19/185,665

(22) Filed: Apr. 22, 2025

(30) Foreign Application Priority Data
Apr. 23, 2024 (JP) 2024-070072

(51) Int. Cl. B41J 29/387; B41J 2/175; B41J 29/13

(52) U.S. Cl. CPC B41J 29/387; B41J 2/1752; B41J 29/13

(57) ABSTRACT

An image forming apparatus on which a plurality of ink containers containing ink of the same color can be mounted includes container loading devices that are detachably loaded with the ink containers, a container cover that is provided in each of the container loading devices and opens and closes a loading port of the container loading device, and a controller that executes a stop process for stopping use of the ink container to stop printing when the ink container loaded in the container loading device with the container cover open is in use when the container cover is opened during printing, but does not execute the stop process not to stop the printing when the ink container loaded in the container loading device with the container cover open is not in use.

### INCORPORATION BY REFERENCE

This application claims priority to Japanese Patent Application No. 2024-070072 filed on Apr. 23, 2024, the entire contents of which are incorporated by reference herein.

### BACKGROUND

The present disclosure relates to an image forming apparatus, and particularly, to replacement of a recording agent container that contains a recording agent such as ink or toner.

There are image forming apparatuses, such as printers and multifunction devices, which are equipped with a container loading device that is detachably loaded with a recording agent container (for example, an ink container) containing a recording agent such as ink or toner, and a container cover that opens and closes a loading port of the container loading device. In addition, such image forming apparatuses have a printing stop function of stopping printing when the container cover is opened during printing.

### SUMMARY

As one aspect of the disclosure, technology that further improves the above technology is proposed.

An image forming apparatus according to one aspect of the disclosure includes an image forming device, a controller, a container loading device, a container cover, and a cover opening/closing sensor. The image forming device forms an image on a recording medium using a recording agent. The controller includes a processor and functions as a controller that controls the operation of the image forming device and performs printing by executing a control program by the processor. The container loading device is provided for each of the recording agent containers in a container loading device on which a plurality of recording agent containers containing recording agents of the same color are mounted, and is detachably loaded with each recording agent container. The container cover opens and closes a loading port of the container loading device which is provided for each of the container loading devices. The cover opening/closing sensor detects the opening and closing of the container cover. The controller executes a stop process for stopping use of the recording agent container to stop printing when the recording agent container loaded in the container loading device with a container cover open is in use when the container cover is opened during printing on the basis of an open/closed state of the container cover detected by the cover opening/closing sensor and a usage state of the recording agent container, and the controller does not execute the stop process to stop the printing when the recording agent container loaded in the container loading device with a container cover open is not in use.

### BRIEF DESCRIPTION OF THE DRAWINGS

FIG. 1 is a partial cross-sectional front view showing the structure of an image forming system including an image forming apparatus according to an embodiment of the disclosure.

FIG. 2 is a schematic front view showing the structure of a sub-apparatus provided in the image forming apparatus.

FIG. 3 is a schematic functional block diagram showing a main internal configuration of the image forming apparatus.

FIGS. 4A and 4B are diagrams showing an example of a display screen displayed on a display device.

FIG. 5 is a flowchart showing an example of processing performed by a control device in the image forming apparatus.

### DETAILED DESCRIPTION

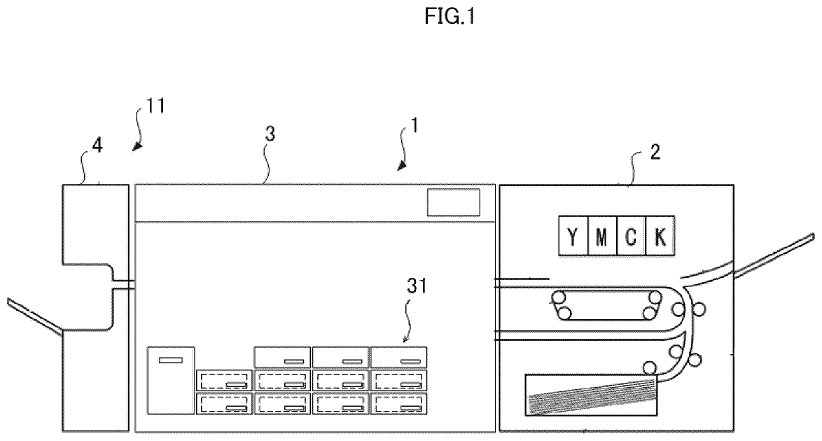

An image forming apparatus according to one embodiment of the disclosure will be described below with reference to the drawings. FIG. 1 is a partial cross-sectional front view showing the structure of an image forming system including the image forming apparatus according to one embodiment of the disclosure.

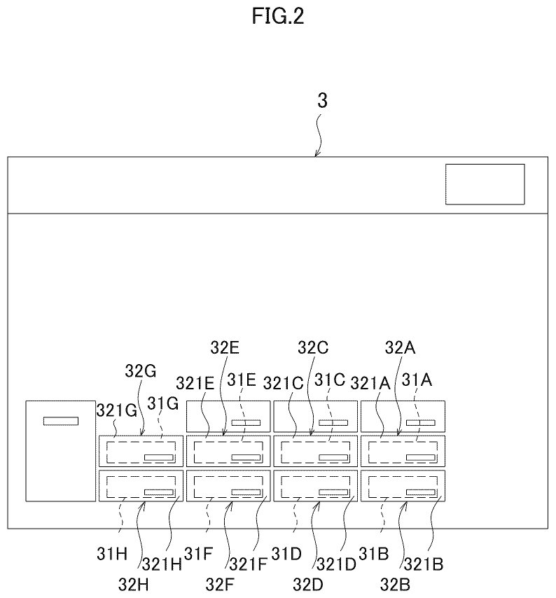

An image forming system 11 includes an image forming apparatus 1 and a post-processing apparatus 4 connected to the image forming apparatus 1. The image forming apparatus 1 is a multifunction device that has a plurality of functions, such as a copy function and a printer function, and forms an image on a recording sheet as a recording medium using ink as a recording agent by an inkjet method. The image forming apparatus 1 includes a main apparatus 2 that forms an image on a recording sheet, and a sub-apparatus 3 that is equipped with an ink container 31 (ink containers 31A to 31H in FIG. 2) containing ink and supplies the ink in the ink container 31 to the main apparatus 2. The ink container 31 is an example of a recording agent container in the claims. The sub-apparatus 3 is an example of a container mounting mechanism in the claims.

FIG. 2 is a schematic front view showing the structure of the sub-apparatus 3 provided in the image forming apparatus 1. The image forming apparatus 1 can be equipped with a plurality of ink containers (here, two ink containers) that contain ink of the same color. As shown in FIG. 2, the sub-apparatus 3 includes container loading devices 32A to 32H that are detachably loaded with the ink containers 31A to 31H shown in dashed rectangular shapes. The container loading devices 32A and 32B are loaded with the ink containers 31A and 31B containing black ink, the container loading devices 32C and 32D are loaded with the ink containers 31C and 31D containing cyan ink, the container loading devices 32E and 32F are loaded with the ink containers 31E and 31F containing magenta ink, and the container loading devices 32G and 32H are loaded with the ink containers 31G and 31H containing yellow ink.

The container loading devices 32A to 32H are respectively provided with container covers 321A to 321H that open and close loading ports of the container loading devices 32A to 32H. The ink containers 31A to 31H, the container loading devices 32A to 32H, and the container covers 321A to 321H will be hereinafter collectively referred to as the ink containers 31, the container loading devices 32, and the container covers 321.

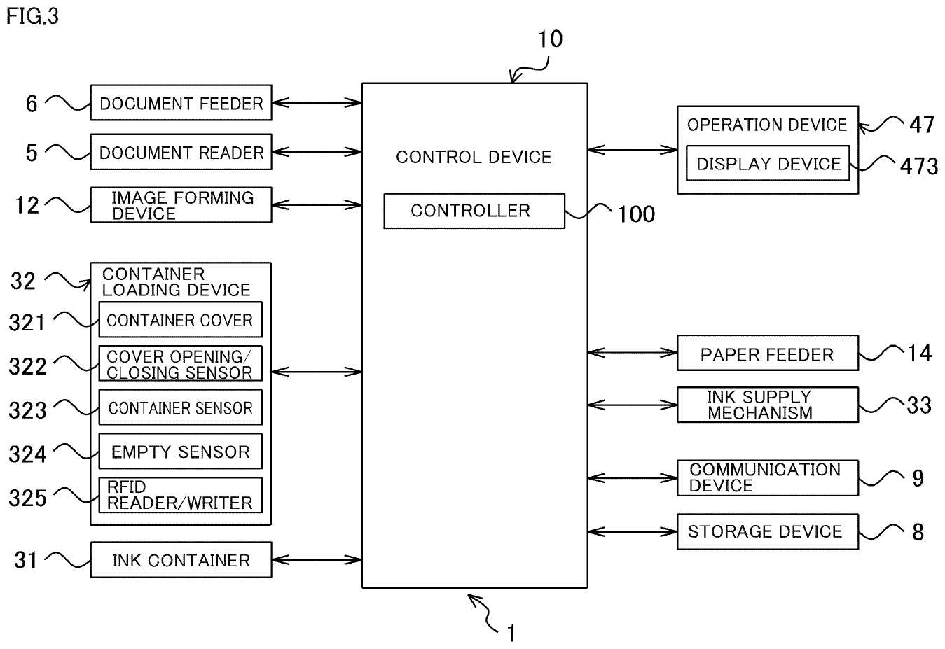

FIG. 3 is a schematic functional block diagram showing a main internal configuration of the image forming apparatus 1. The image forming apparatus 1 includes a control device 10, a document feeder 6, a document reader 5, an image forming device 12, the container loading devices 32, the ink containers 31, a paper feeder 14, an ink supply mechanism 33, an operation device 47, a communication device 9, and a storage device 8.

The document feeder 6 is configured to be openable and closable on the upper surface of the document reader 5 by means of a hinge or the like (not shown), and functions as a document holder cover when reading a document placed on a platen glass (not shown). The document feeder 6 is also an auto document feeder (ADF), includes a document tray (not shown), and supplies documents placed on the document tray one by one to the document reader 5.

The document reader 5 includes a scanner and the like, and reads documents fed from the document feeder 6 or reads documents placed on the platen glass. In addition, the document reader 5 can sequentially read a plurality of document images transmitted from the document feeder 6.

A case where the image forming apparatus 1 performs a document reading operation will be described. The document reader 5 optically reads an image of a document supplied to the document reader 5 by the document feeder 6 or a document placed on the platen glass, and generates image data. The image data generated by the document reader 5 is stored in an image memory (not shown) or the like.

A case where the image forming apparatus 1 performs an image forming operation will be described. The image forming device 12 is equipped with ink heads for ejecting ink droplets of respective colors (black, cyan, magenta, and yellow), a printing transport device, and a dry transport device. The image forming device 12 forms an image on a recording sheet as a recording medium which is fed from the paper feeder 14 by using the ink contained in the ink container 31 loaded in the container loading device 32 by an inkjet method on the basis of image data generated by a document reading operation, image data stored in the image memory or the like, image data received from a computer connected to a network, or the like.

The printing transport device includes an endless transport belt, and transports a recording sheet opposite the ink head by using the transport belt. Similarly to the printing transport device, the dry transport device also includes an endless transport belt, and transports a recording sheet on which an image has been formed by using the transport belt to naturally dry ink adhering to the recording sheet.

The recording sheet on which an image has been formed by the image forming device 12 is transported to the post-processing apparatus 4 (FIG. 1) via the sub-apparatus 3 (FIG. 1), and if necessary, post-processing such as stapling is performed by the post-processing apparatus 4.

The paper feeder 14 includes a plurality of paper feed cassettes, and further includes a pick-up roller that picks up recording sheets from the paper feed cassettes and feeds them to the image forming device 12, a transport roller, a transport path, and a rotation drive mechanism for each roller.

Each container loading device 32 is provided with a container cover 321, a cover opening/closing sensor 322, a container sensor 323, an empty sensor 324, and a radio frequency identification (RFID) reader/writer 325. The cover opening/closing sensor 322 detects the opening and closing of the container cover 321, and is, for example, a limit switch that is turned on and turned off depending on whether the container cover 321 is open or closed.

The container sensor 323 detects whether there is an ink container 31 loaded in the container loading device 32, and is, for example, a limit switch that is turned on and turned off depending on whether the ink container 31 is attached or detached. The empty sensor 324 detects whether there is ink in the ink container 31 loaded in the container loading device 32 (empty state), and is, for example, an optical sensor.

The RFID reader/writer 325 reads and writes data from and on a RFID tag (not shown) attached to the ink container 31 loaded in the container loading device 32. To the RFID tag, a unique product serial number, color information, expiration date information, and the like are written, and an initial value of an ink capacity is written as remaining ink amount information at the time of shipment from the factory.

The controller 100, which will be described later, reads the remaining ink amount information stored in the RFID tag via, for example, the RFID reader/writer 325. Thereby, the image forming apparatus 1 (controller 100) can recognize the remaining ink amount in the ink container 31. In addition, when ink is used (such as during printing or maintenance), the controller 100 detects the amount of ink consumed (for example, counts the number of times ink is ejected from the ink head to calculate the amount of ink consumed), calculates the remaining ink amount in the ink container 31 from the detected amount of ink consumed, appropriately writes information indicating the calculated remaining ink amount on the RFID tag via the RFID reader/writer 325, and updates the remaining ink amount information stored in the RFID tag.

When the ink container 31 is a genuine product, the RFID reader/writer 325 can perform appropriate wireless communication with the RFID tag. However, when the ink container 31 is not a genuine product, the RFID reader/writer 325 cannot perform appropriate wireless communication with the RFID tag and may not be able to acquire the remaining ink amount information of the ink container 31. It is possible to determine whether the ink container 31 is a genuine product from the product serial number written on the RFID tag.

The ink supply mechanism 33 supplies the ink in the ink container 31 loaded in the container loading device 32 to the image forming device 12. For example, the ink supply mechanism 33 includes a syringe pump, a plurality of pipes, a valve, and a coil spring, connects an ink supply port of the ink container 31 to the syringe pump with the pipes, and connects the syringe pump to the image forming device 12 with the pipes. The ink supply port is opened and closed by the valve, and the valve is biased by the coil spring.

The operation device 47 includes various hard keys operated by a user, and receives instructions, such as an image forming operation execution instruction, from the user for various operations and processes that can be executed by the image forming apparatus 1 in response to the operation of the hard keys.

The operation device 47 includes a display device 473 that displays operation guides and the like to the operator. In addition, the operation device 47 receives an input of an instruction from the user based on the user's operation (touch operation) on a screen displayed on the display device 473 via a touch panel of the display device 473.

The display device 473 is configured with a liquid crystal display (LCD) or the like. When the operator touches a button or a key displayed on the screen, the touch panel receives an instruction associated with the touched position. In this case, the touch panel functions as an operation device.

The communication device 9 is a communication interface that transmits and receives various data to and from external devices (for example, a personal computer and a server) in a local area or on the Internet.

The storage device 8 is a large-capacity storage device such as a hard disk drive (HDD) or a solid state drive (SSD), and stores various control programs and the like.

The control device 10 includes a processor, a random access memory (RAM), a read only memory (ROM), and a dedicated hardware circuit. The processor is, for example, a central processing unit (CPU), an application specific integrated circuit (ASIC), a micro processing unit (MPU), or the like. The control device 10 includes the controller 100.

The control device 10 functions as the controller 100 by the operation of the processor according to a control program stored in the storage device 8. However, the controller 100 can also be configured with a hardware circuit, regardless of the operation according to the control program by the control device 10. The same applies to each embodiment unless otherwise stated below.

The controller 100 is responsible for controlling the overall operation of the image forming apparatus 1. The controller 100 is connected to the document feeder 6, the document reader 5, the image forming device 12, the container loading device 32, the ink container 31, the paper feeder 14, the ink supply mechanism 33, the operation device 47, the communication device 9, and the storage device 8, controls the driving of each of these devices, and executes various processes necessary for image formation by the image forming apparatus 1. For example, the controller 100 controls the operation of the image forming device 12 to perform printing. At this time, the controller 100 prioritizes an ink container 31 with the shortest period until its use expiration date or an ink container 31 with the least remaining amount of recording agent among the plurality of ink containers 31 that contain ink of the same color, and uses the prioritized ink container for printing.

In addition, the controller 100 executes a predetermined special process according to the open/closed state of the container cover 321 detected by the cover opening/closing sensor 322 and the usage state of the ink container 31 on the basis of the states. The contents of the special process will be described in the following two cases 1 and 2.
<Case 1> shows the contents of the special process when the ink container 31 loaded in the container loading device 32 with the container cover 321 open is in use (toner is supplied to the image forming device 12) when the container cover 321 is opened during printing. <Case 1> will be further described in two cases.
<Case 2> shows the contents of the special process when the ink container 31 loaded in the container loading device 32 with the container cover 321 open is not in use when the container cover 321 is opened during printing.

### Case 1-1

When the ink container 31 loaded in the container loading device 32 with the container cover 321 open is in use when the container cover 321 is opened during printing, the controller 100 stops printing by executing a stop process for stopping the use of the ink container 31 with the container cover 321 open, as the special process described above. For example, the controller 100 stops the use of the ink container 31 by controlling the coil spring of the ink supply mechanism 33 to close the ink supply port of the ink container 31.

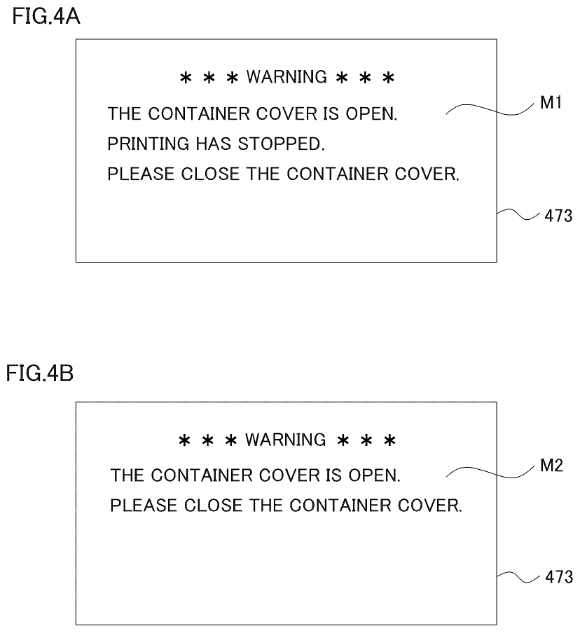

The controller 100 also executes a notification process for notifying the user that the container cover 321 has been opened during printing. For example, the controller 100 controls the display of the display device 473 to display a message M1 such as “The container cover is open. Printing has stopped. Please close the container cover.” on the display device 473, as shown in FIG. 4A.

### Case 1-2

When the ink container 31 loaded in the container loading device 32 with the container cover 321 open is in use, but another ink container 31 that contains the same color ink as the ink contained in the ink container 31 and satisfies predetermined usage conditions is loaded in the container loading device 32, the controller 100 executes the above-described stop process as the above-described special process, but does not stop printing, and continues printing using the other ink container 31 that satisfies the above-described usage conditions. The above-described usage conditions include a condition that the container cover 321 is closed and a condition that the ink container is not in an empty state.

The above-described contents will be specifically described using the ink containers 31A and 31B that contain black ink as an example. When the container cover 321A of the container loading device 32A in which the ink container 31A is loaded is opened during printing, and the container cover 321B of the container loading device 32B in which the ink container 31B is loaded is closed and the ink container 31B is not in an empty state, the above-described usage conditions are satisfied, and thus the controller 100 controls the coil spring of the ink supply mechanism 33 to close the ink supply port of the ink container 31A and open the ink supply port of the ink container 31B, thereby continuing printing.

The controller 100 also executes a notification process for notifying the user that the container cover 321 has been opened during printing. For example, the controller 100 controls the display of the display device 473 to display a message M2 such as “The container cover is open. Please close the container cover.” on the display device 473, as shown in FIG. 4B.

### Case 2

When the ink container 31 loaded in the container loading device 32 with the container cover 321 open is not in use when the container cover 321 is opened during printing, the controller 100 does not execute the above-described stop process and does not stop printing.

The controller 100 also executes a notification process for notifying the user that the container cover 321 has been opened during printing. For example, the controller 100 controls the display of the display device 473 to display the message M2 such as “The container cover is open. Please close the container cover.” on the display device 473, as shown in FIG. 4B, similar to <Case 1-2>described above.

Which process of the above-described “Case 1-1: printing stop” and “Case 1-2: printing continuation” is to be executed may be set by the user in accordance with, for example, the contents of an instruction received by operating the operation device 47. The controller 100 executes the process of the above-described “Case 1-1: printing stop” or “Case 1-2: printing continuation” in accordance with the user setting received by the operation device 47.

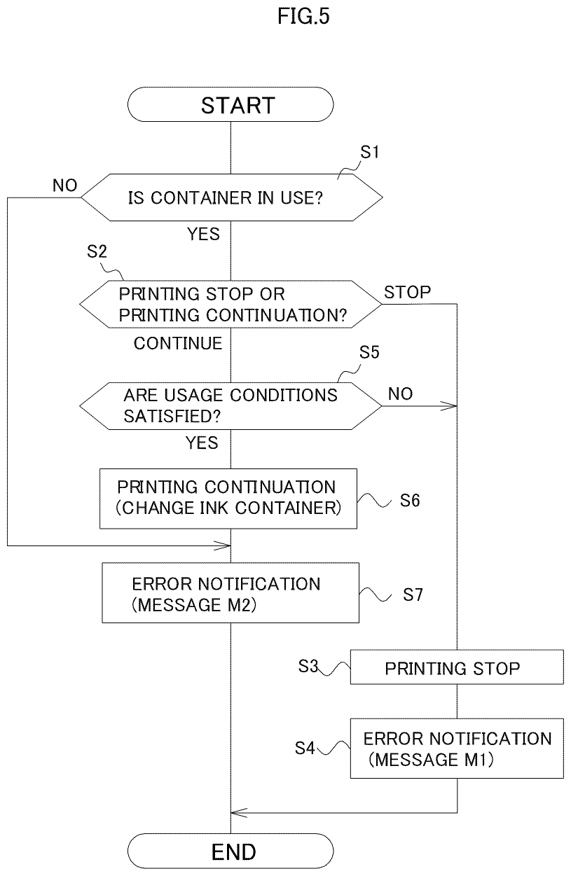

Next, an example of a process related to monitoring of the opening and closing of the container cover 321 which is performed by the control device 10 of the image forming apparatus 1 will be described using a flowchart shown in FIG. 5. This process is performed when the cover opening/closing sensor 322 detects the opening of the container cover 321.

When the cover opening/closing sensor 322 detects the opening of the container cover 321, the controller 100 determines whether the ink container 31 loaded in the container loading device 32 with the container cover 321 open is in use (S1).

When the controller 100 determines that the ink container 31 is in use (YES in S1), it determines whether the user setting previously received by the operation device 47 is “printing stop” or “printing continuation” (S2).

When the controller 100 determines that the user setting is “printing stop” (“stop” in S2), it closes the ink supply port of the ink container 31 loaded in the container loading device 32 with the container cover 321 open, thereby stopping its use and stopping printing (S3), and displays the message M1 as shown in FIG. 4A on the display device 473 (S4). Thereafter, the process ends.

On the other hand, when the controller 100 determines that the user setting is “printing continuation” (“continue” in S2), it determines whether another ink container 31 that contains the same color ink as the ink contained in the ink container 31 and satisfies the above-described usage conditions is loaded in the container loading device 32 (S5).

When the controller 100 determines that another ink container 31 that satisfies the above-described usage conditions is loaded in the container loading device 32 (YES in S5), the controller 100 closes the ink supply port of the ink container 31 loaded in the container loading device 32 with the container cover 321 open to stop its use, opens the ink supply port of the other ink container 31 that satisfies the above-described usage conditions to continue printing (S6), and displays the message M2 as shown in FIG. 4B on the display device 473 (S7). Thereafter, the process ends.

On the other hand, when the controller 100 determines that another ink container 31 that satisfies the above-described usage conditions is not loaded in the container loading device 32 (NO in S5), it closes the ink supply port of the ink container 31 to stop its use and stop printing (S3), and displays the message M1 as shown in FIG. 4A on the display device 473 (S4). Thereafter, the process ends.

In addition, when the controller 100 determines in S1 that the ink container 31 loaded in the container loading device 32 with the container cover 321 open is not in use (NO in S1), there is no effect on printing, and thus the message M2 as shown in FIG. 4(B) is displayed on the display device 473 (S7). Thereafter, the process ends.

According to the above embodiment, when there is no effect on printing even when the container cover 321 is opened during printing, the printing will not be stopped, and thus the user can replace the ink container 31 while continuing the printing. In addition, since the ink container 31 used for printing can be changed even during printing, the ink container 31 that was in use until just before can be replaced while continuing the printing. Thereby, it is possible to avoid a situation where productivity is reduced due to the replacement of the toner container.

For open/close information of the container cover 321 which is obtained from the cover opening/closing sensor 322, presence/absence information of the ink container 31 which is obtained from the container sensor 323, empty information obtained from the empty sensor 324, and ink remaining amount information obtained from the RFID tag, the controller 100 may control the display on the display device 473 to appropriately display them on the display device 473 and may inform the user of the information.

The disclosure is not limited to the configuration of the above embodiment, and various modifications can be made. Further, in the above embodiment, the configurations and processes shown in the above embodiment using FIGS. 1 to 5 are merely one embodiment of the disclosure, and it is not intended to limit the disclosure to the configurations and processes.

In the case of a dual-container image forming apparatus equipped with a plurality of (for example, two) recording agent containers that contain recording agents of the same color for the purpose of improving downtime due to running-out of consumables such as ink, which is different from the present embodiment, for example, an image forming apparatus equipped with an ink tank and ink cartridge having different capacities, regarding a printing stop function according to the opening and closing of a toner container cover, the image forming apparatus stops printing even when a container cover of the recording agent container that is not being used in the dual container is opened. For this reason, in order to replace the recording agent container, printing needs to be stopped temporarily, which reduces productivity. In contrast, according to the above embodiment, it is possible to replace the recording agent container without stopping printing.

While the disclosure has been described in detail with reference to the embodiments thereof, it would be apparent to those skilled in the art that the various changes and modifications may be made therein within the scope defined by the appended claims.

What is claimed is:

1. An image forming apparatus comprising:
an image forming device that forms an image on a recording medium using a recording agent;
a control device that includes a processor and functions as a controller that controls an operation of the image forming device to perform printing by executing a control program by the processor;
container loading devices that are detachably loaded with a plurality of recording agent containers in a container loading mechanism on which the respective recording agent containers each containing recording agents of the same color are mounted;
a container cover that opens and closes a loading port of the container loading device which is provided in each of the container loading devices; and
a cover opening/closing sensor that detects the opening and closing of the container cover,
wherein the controller executes a stop process for stopping use of the recording agent container to stop printing when the recording agent container loaded in the container loading device with a container cover which has been opened is in use when the container cover is opened during printing on the basis of an open/closed state of the container cover detected by the cover opening/closing sensor and a usage state of the recording agent container, and the controller does not execute the stop process to stop the printing when the recording agent container loaded in the container loading device with a container cover which has
been opened is not in use.

2. The image forming apparatus according to claim 1, wherein, when the container cover is opened during printing, the controller executes a notification process for notifying a user of the opening.

3. The image forming apparatus according to claim 1, wherein, when the recording agent container loaded in the container loading device with the container cover open is in use, but there is another recording agent container that is not in an empty state, contains a recording agent of the same color as the recording agent contained in the recording agent container, and is loaded in the container loading device with the container cover closed, the controller executes the stop process for the recording agent container loaded in the container loading device with the container cover open, and continues the printing by using the other recording agent container.

4. The image forming apparatus according to claim 3, further comprising an operation device that receives an instruction from a user,
wherein, in accordance with contents of the instruction received by the operation device, the controller executes, as a process performed when the recording agent container loaded in the container loading device with the container cover open is in use, either
(i) a process of executing a stop process for stopping use of the recording agent container loaded in the container loading device with the container cover open to stop printing, or
(ii) a process of executing the stop process for the recording agent container loaded in the container loading device with the container cover open when there is another recording agent container that contains a recording agent of the same color as the recording agent contained in the recording agent container loaded in the container loading device with the container cover open and is not in an empty state where the recording agent container is loaded in the container loading device with the container cover closed, and continuing the printing by using the other recording agent container.

5. The image forming apparatus according to claim 1, wherein the controller prioritizes a recording agent container with the shortest period until its use expiration date or a recording agent container with the least remaining amount of recording agent among the plurality of recording agent containers that contain recording agents of the same color, and uses the prioritized recording agent container for printing.
